(19) United States
(12) Patent Application Publication
(10) Pub. No.: US 2025/0328548 A1
(43) Pub. Date: Oct. 23, 2025

(54) Inline Nested Data Loss Protection (DLP)

(71) Applicant: Zscaler, Inc., San Jose, CA (US)

(72) Inventors: Weizhen Liu, San Jose, CA (US); Miao Zhang, Sunnyvale, CA (US); Zhen Yu, San Jose, CA (US)

(73) Assignee: Zscaler, Inc., San Jose, CA (US)

(21) Appl. No.: 19/255,260

(22) Filed: Jun. 30, 2025

Related U.S. Application Data
(63) Continuation-in-part of application No. 18/735,880, filed on Jun. 6, 2024.
(63) Continuation-in-part of application No. 18/584,354, filed on Feb. 22, 2024.

(51) Int. Cl. G06F 16/28; G06F 21/60; G06F 40/30

(52) U.S. Cl. CPC G06F 16/285; G06F 21/602; G06F 40/30

(57) ABSTRACT

The disclosure presents systems and methods for hierarchical classification of input data across a plurality of categories. A machine learning model processes various data formats, starting with dimensional reduction using tokenization techniques, such as Bert-tiny tokenization, to create model-readable representations. The system predicts super-categories, sub-categories, and granular categories through selective activation of sub-layers tied to identified super-categories, optimizing computational efficiency. Label smoothing during training mitigates overconfidence in predictions, while softmax normalization refines inference outputs. Synthetic data generation using Large Language Models (LLMs) supplements training datasets, and an automated data labeling pipeline efficiently generates hierarchical labels. Modifications to the model, such as stop word removal and file size limitations, further reduce latency. Inference analyzes logits to predict hierarchical paths, providing detailed classifications with clear outputs. The method is adaptable for multimodal formats, ensuring scalable and accurate predictions across diverse data types while minimizing computational costs and improving reliability.

### CROSS-REFERENCE TO RELATED APPLICATION(S)

The present disclosure is a continuation-in-part of U.S. patent application Ser. No. 18/735,880, filed Jun. 6, 2024, entitled “Inline Multimodal Data Loss Protection (DLP) Using Fine-Tuned Image and Text Models” which is a continuation-in-part of U.S. patent application Ser. No. 18/584,354, filed Feb. 22, 2024, entitled “Multimodal Data Loss Protection using artificial intelligence” the contents of which are incorporated by reference in their entirety.

### FIELD OF THE DISCLOSURE

The present disclosure generally relates to computer networking systems and methods, particularly focused on securing sensitive data. More particularly, the present disclosure relates to systems and methods for inline nested Data Loss Protection (DLP).

### BACKGROUND OF THE DISCLOSURE

In the era of increasing data proliferation, organizations face significant challenges in safeguarding sensitive information, particularly through accurate and scalable DLP systems. Traditional DLP solutions often rely on rule-based approaches or simplistic classification methods, which struggle to handle the growing complexity and diversity of data types, formats, and hierarchical categories. These systems frequently encounter issues such as overconfidence in predictions, insufficient labeled data for training, and high computational costs, limiting their ability to provide reliable results across diverse scenarios. To address these limitations, advancements in hierarchical classification and machine learning techniques, including tokenization, Large Language Models (LLMs), automated data labeling pipelines, and synthetic data generation, have emerged as transformative solutions. By integrating these innovations into DLP systems, the disclosed methods enable accurate identification and categorization of sensitive information, ensuring robust protection, scalable performance, reduced latency, and enhanced reliability across multimodal and nested data structures.

### BRIEF SUMMARY OF THE DISCLOSURE

The disclosed systems and methods introduce an advanced approach for enhancing Data Loss Protection (DLP) through hierarchical classification and innovative machine learning techniques. The system processes input data across various formats, such as text, images, and PDFs, by first tokenizing and reducing dimensionality using methods like Bert-tiny tokenization. It employs a hierarchical classification model to predict super-categories, sub-categories, and granular categories, enabling precise categorization of sensitive information. Selective activation of sub-layers based on the identified super-category optimizes computational efficiency and reduces latency.

To address challenges like data scarcity and overconfidence in predictions, the system incorporates synthetic data generation using Large Language Models (LLMs), ensuring robust training datasets, and applies label smoothing during training and softmax normalization during inference for well-calibrated predictions. An automated data labeling pipeline powered by LLMs generates consistent and scalable hierarchical labels, further enhancing accuracy. Additionally, the system implements modifications, such as stop word removal, lemmatization, and file size limitations, to streamline processing and improve performance. Designed to handle diverse and multimodal data, the system delivers efficient, scalable, and reliable DLP classification while minimizing computational costs and ensuring robust information protection.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of three example network configurations of cybersecurity monitoring of a user.

FIG. 1B is a logical diagram of the cloud from FIG. 1A operating as a zero-trust platform.

FIG. 2 is a block diagram of a server.

FIG. 3 is a block diagram of a user device.

FIG. 4 is a diagram of a multimodal DLP system for analyzing different input file formats with various tool.

FIG. 5 is a screenshot of an example output of the a multimodal DLP system of FIG. 4.

FIG. 6 is a flowchart of a multimodal DLP with artificial intelligence process.

FIG. 7 is a screenshot of three sample images that are closely similar to one another.

FIG. 8 is a flowchart of a process for an example implementation of the sensitive data classifier step of the multimodal DLP with artificial intelligence process of FIG. 6 using a combination of an LLM and zero-shot classifiers.

FIG. 9 is a flowchart of a process 500 for an example implementation of the sensitive content identifier of the multimodal DLP with artificial intelligence process of FIG. 6 using a combination of CLIP embedding and supervised learning XGboost.

FIG. 10 is a table of example of categorization results using the process of FIG. 9.

FIG. 11 is a table of examples of sub-category results.

FIG. 12 is a flowchart of a process for multimodal DLP.

FIG. 13 is a diagram representing image size vs load time for a plurality of image file types.

FIG. 14 is a plurality of estimated load time vs image size trend graphs for various image file types.

FIG. 15 is a flow diagram of a composite text and image classification architecture.

FIG. 16 is a flowchart of a process for inline multimodal DLP.

FIG. 17 is a flow diagram of a data labeling pipeline.

FIG. 18 is a flow diagram of a model training process.

FIG. 19 is a flowchart of a process for inline nested DLP

### DETAILED DESCRIPTION OF THE DISCLOSURE

Again, the present disclosure relates to Data Loss Protection (DLP) by employing hierarchical classification and advanced machine learning techniques. It processes diverse input formats, such as text, images, and PDFs, using tokenization and dimensional reduction methods like Bert-tiny tokenization. The model predicts super-categories, sub-categories, and granular categories, leveraging selective activation of sub-layers to improve efficiency and reduce latency. Synthetic data generation and automated labeling pipelines powered by Large Language Models (LLMs) ensure robust training datasets and consistent hierarchical labeling. To address overconfidence, label smoothing during training and softmax normalization during inference are applied for calibrated predictions. Additional optimizations include stop word removal, lemmatization, and file size constraints to streamline processing. This versatile system offers scalable, accurate, and efficient data classification, making it highly effective for safeguarding sensitive information across multimodal formats and complex hierarchical structures.

### § 1.0 Cybersecurity Monitoring and Protection Examples

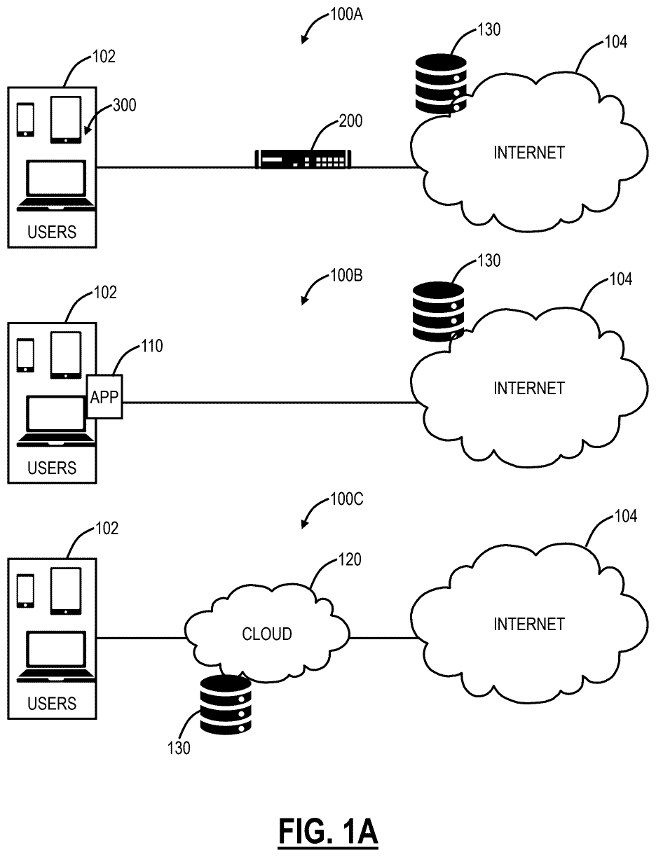

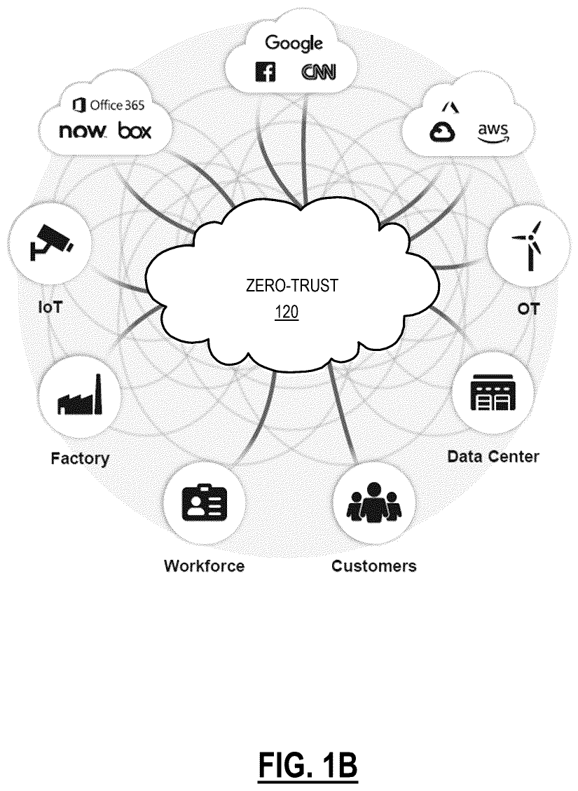

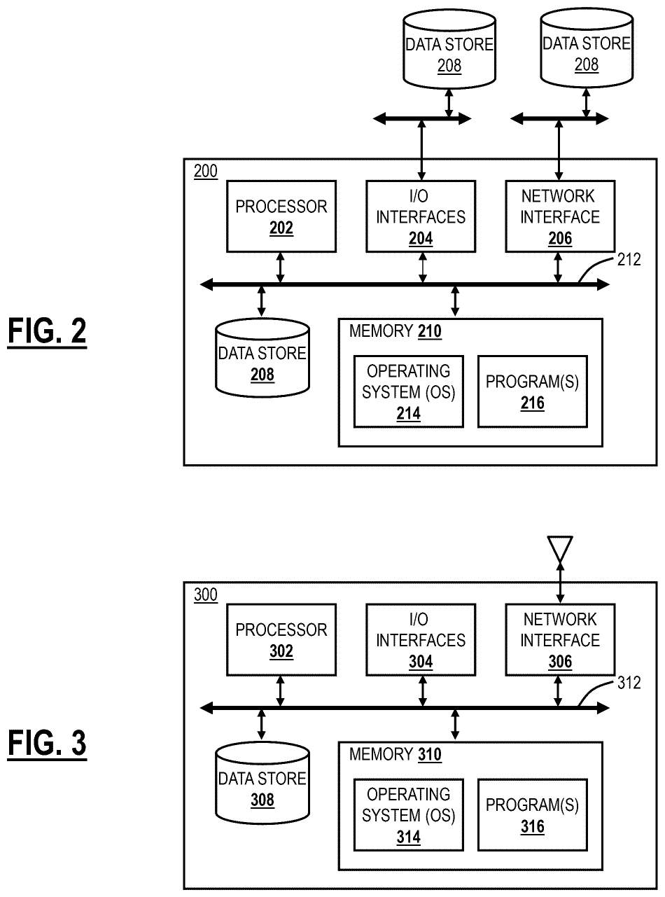

FIG. 1A is a network diagram of three example network configurations 100A, 100B, 100C of cybersecurity monitoring and protection of a user 102. Those skilled in the art will recognize these are some examples for illustration purposes, there may be other approaches to cybersecurity monitoring, and these various approaches can be used in combination with one another as well as individually. Also, while shown for a single user 102, practical embodiments will handle a large volume of users 102, including multi-tenancy. In this example, the user 102 (having a user device 300 such as illustrated in FIG. 3) communicates on the Internet 104, including accessing cloud services, Software-as-a-Service, etc. (each may be offered via compute resources, such as using one or more servers 200 as illustrated in FIG. 2). As part of offering cybersecurity through these example network configurations 100A, 100B, 100C, there is a large amount of cybersecurity data obtained. The present disclosure focuses on using this cybersecurity data for various purposes.

The network configuration 100A includes a server 200 located between the user 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located inline with the user 102 and configured to monitor the user 102. In other embodiments, the server 200 does not have to be inline. For example, the server 200 can monitor requests from the user 102 and responses to the user 102 for one or more security purposes, as well as allow, block, warn, and log such requests and responses. The server 200 can be on a local network associated with the user 102 as well as external, such as on the Internet 104. The network configuration 100B includes an application 110 that is executed on the user device 300. The application 110 can perform similar functionality as the server 200, as well as coordinated functionality with the server 200. Finally, the network configuration 100C includes a cloud service 120 configured to monitor the user 102 and perform security-as-a-service. Of course, various embodiments are contemplated herein, including combinations of the network configurations 100A, 100B, 100C together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 100C. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the users 102, using signatures sourced and constantly updated. The DNS security can identify and route command-and-control connections to threat detection engines for full content inspection. The DLP can use standard and/or custom dictionaries to continuously monitor the users 102, including compressed and/or Secure Sockets Layer (SSL)-encrypted traffic.

In some embodiments, the network configurations 100A, 100B, 100C can be multi-tenant and can service a large volume of the users 102. Newly discovered threats can be promulgated for all tenants practically instantaneously. The users 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of users 102 under management by an IT group, department, administrator, etc., i.e., some group of users 102 that are managed together. One advantage of multi-tenancy is the visibility of cybersecurity threats across a large number of users 102, across many different organizations, across the globe, etc. This provides a large volume of data to analyze, use artificial intelligence techniques on, develop comparisons, etc.

Of course, the cybersecurity techniques above are presented as examples. Those skilled in the art will recognize other techniques are also contemplated herewith. That is, any approach to cybersecurity that can be implemented via any of the network configurations 100A, 100B, 100C. Also, any of the network configurations 100A, 100B, 100C can be multi-tenant with each tenant having its own users 102 and configuration, policy, rules, etc.

### § 1.1 Cloud Monitoring

The cloud 120 can scale cybersecurity monitoring and protection with near-zero latency on the users 102. Also, the cloud 120 in the network configuration 100C can be used with or without the application 110 in the network configuration 100B and the server 200 in the network configuration 100A. Logically, the cloud 102 can be viewed as an overlay network between users 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the users 102, as well as independent of platform, operating system, network access technique, network access provider, etc.

There are various techniques to forward traffic between the users 102 and the cloud 120. A key aspect of the cloud 120 (as well as the other network configurations 100A, 100B) is all traffic between the users 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 100C, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software as a Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### § 1.2 Zero Trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120 Zero trust is a cybersecurity strategy wherein security policy is applied based on context established through least-privileged access controls and strict user authentication—not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multifactor authentication (MFA) methods beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:

Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time—before it reaches its destination—to prevent ransomware, malware, and more.

Protect data using granular context-based policies: Zero trust policies verify access requests and rights based on context, including user identity, device, location, type of content, and the application being requested. Policies are adaptive, so user access privileges are continually reassessed as context changes.

Reduce risk by eliminating the attack surface: With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### § 2.0 Example Server Architecture

FIG. 2 is a block diagram of a server 200, which may be used in as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc.

### § 3.0 Example User Device Architecture

FIG. 3 is a block diagram of a user device 300, which may be used by a user 102. Specifically, the user device 300 can form a device used by one of the users 102, and this may include common devices such as laptops, smartphones, tablets, netbooks, personal digital assistants, cell phones, e-book readers, Internet-of-Things (IoT) devices, servers, desktops, printers, televisions, streaming media devices, storage devices, and the like. The user device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the user device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the user device 300, a semiconductor-based microprocessor (in the form of a microchip or chipset), or generally any device for executing software instructions. When the user device 300 is in operation, the processor 302 is configured to execute software stored within the memory 310, to communicate data to and from the memory 310, and to generally control operations of the user device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the user device 300. For example, example programs 316 may include, but not limited to, a web browser, social networking applications, streaming media applications, games, mapping and location applications, electronic mail applications, financial applications, and the like. The application 110 can be one of the example programs.

### § 4.0 Data Loss

DLP involves monitoring of an organization's sensitive data, including data at endpoint devices, data at rest (i.e., stored somewhere), and data in motion (i.e., being transmitted somewhere). DLP monitoring approaches focus on a variety of products, including software agents at endpoints, physical appliances, virtual appliances, etc. As applications move to the cloud, users are accessing them directly, everywhere they connect, inevitably leaving blind spots as users bypass security controls in conventional DLP approaches while off-network. As such, previously referenced U.S. Pat. No. 11,829,347, issued Nov. 28, 2023, and entitled “Cloud-based data loss prevention,” describes cloud-based techniques.

The present disclosure includes an artificial intelligence based approach to DLP that categorizes data into one of a plurality of categories. Those skilled in the art will recognize this approach can be used in any system architecture, including the network configurations 100A, 100B, 100C of cybersecurity monitoring and protection, variants thereof, as well as other approaches known in the art. Further, the artificial intelligence based approach can be used in combination with existing DLP approaches known in the art.

### § 4.1 Conventional DLP

Generally, all of these existing techniques utilize DLP dictionaries which include specific kinds of information in users' traffic and information as well as custom information. For example, specific kinds of information can look for types of data, e.g., Personally Identifiable Information (PII), bank information, credit card information, etc. That is, the specific information can detect something based on its format with a simple example being a social security number which is formatted as XXX-XX-XXX. The custom information can be specific keywords from a company, e.g., customer names, product names, etc. Also, the custom information can be specific documents, i.e., the sensitive information itself. That is, DLP can detect keywords, specific kinds of information, and actual documents as well as portions of actual documents.

With the dictionaries, there can be different techniques to detect this information, including Exact Data Matching (EDM) where specific keywords, classes of data, etc. are flagged. For example, DLP can detect social security numbers, credit card numbers, etc. based on the data format, such as in structured documents, etc. There can also be an approach in unstructured documents referred to as Indexed Document Matching (IDM) to identify and protect content that matches the whole or some part of a document from a repository of documents. Further, either of these approaches can be performed with Optical Character Recognition (OCR) as well to cover non-text data.

Again, these approaches work well but have a couple of disadvantages. First, these approaches require up-front dictionaries. For the specific kinds of information, DLP monitoring systems typically offer predefined dictionaries for the specific kinds of information. So, IT can preselect these dictionaries. For the repository of documents, IT has to provide this information. To address the desire to avoid sharing sensitive information, approaches provide hashing to allow detection of the sensitive information without sharing the actual sensitive information. However, a key point here is the need to provide information and/or select dictionaries in advance. One further disadvantage is these approaches tend to be overly restrictive (false positives) or miss critical information (false negatives). In the overly restrictive case, users 102 are prohibited from exchanging data that falls into a rule, e.g., blocking and reporting an email which looks like it has banking or PII information, but when this information actually belongs to the user 102. Also, new documents may be missed if they are not in the provided repository.

### § 4.2 Multimodal DLP with Artificial Intelligence

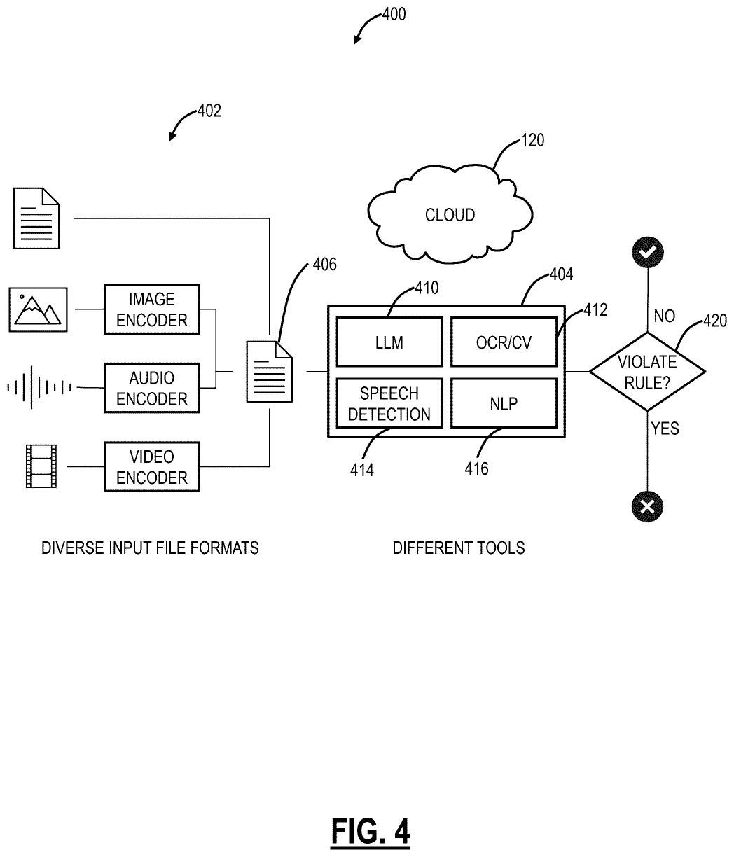

FIG. 4 is a diagram of a multimodal DLP system 400 for analyzing different input file formats 402 with various tools 404. The multimodal DLP system 400 is referred to as a system and those skilled in the art will recognize this can be implemented as a method with steps, via a non-transitory computer-readable medium with instructions that cause one or more processors to implement the steps, and via computing resources configured to implement the steps. For example, the computing resources can include the cloud 120, the server 200, the user device 300, etc.

The multimodal DLP system 400 is referred to as multimodal meaning it can understand or generate information across multiple modes or types of data. In the context of artificial intelligence and machine learning, the multimodal DLP system 400 can process and integrate information from various modalities, such as text, images, sound, video and more. Traditional DLP solutions are limited to understanding and managing text and image-based data, and the world has transitioned to a broader set of visual and audio multimedia formats. The multimodal DLP system 400 enhances the way DLP will operate by integrating generative AI and multi-modal capabilities to protect customers' data from leakage across various media formats beyond text and images, such as video and audio formats.

As such, the input file formats 402 contemplate any type of content which can be used to convey information. The input file formats 402 can be images, text, audio, video, and combinations thereof. In particular, the input file formats 402 can extend beyond anything that can be reduced to text. For example, traditional approaches look for text in images or video, such as via OCR, and for text in audio, such as via converting the audio to text. With artificial intelligence and machine learning, the DLP detection is not limited to text, but can extend to pure images and the like. That is, the output of multimodal DLP system 400 is not merely a verdict that some sensitive data is contained in a file, but rather can be to classify the type of content.

In various embodiments, the collective input file formats 402 can include, without limitation, image formats, video formats, text formats, spreadsheets, Comma Separated Values (CSV) formats, source code, presentation formats, Portable Document Format (PDF), and the like. The collective input file formats 402 can be a single input 406 to the tools 404 in the multimodal DLP system 400. The various tools 404 can include one or more Large Language Models (LLMs) 410, an OCR/Computer Vision (CV) system 412, a speech detection system 414, and a Natural Language Processing (NLP) system 416. In some embodiments, the particular tool 404 can be used based on the file format 402. In other embodiments, multiple tools 404 can be used on the same file, e.g., an audio file can be processed by the speech detection system 414 and then processed by the LLMs 410 and/or the NLP system 416. Similarly, in some embodiments, an image or video file can be processed by the OCR/CV system 412 and then processed by the LLMs 410 and/or the NLP system 416. In various embodiments, all different file formats 402 can be processed by the LLMs 410.

The present disclosure contemplates using one or more tools 404 based on the different file formats 402. In an embodiment, the following models were used in the tools 404, individually and in combination with one another:
(1) BLIP (Bootstrapping Language-Image Pre-training), see, e.g., Li, Junnan, et al. “Blip: Bootstrapping language-image pre-training for unified vision-language understanding and generation.” International Conference on Machine Learning. PMLR, 2022, the contents of which are incorporated by reference in their entirety. The BLIP model is capable of processing images.
(2) Video LLaMA (Large Language Model Meta AI), see, e.g., Zhang, Hang, Xin Li, and Lidong Bing. “Video-llama: An instruction-tuned audio-visual language model for video understanding.” arXiv preprint arXiv:2306.02858 (2023), the contents of which are incorporated by reference in their entirety. The Video LLaMA model is capable of processing images and videos.
(3) LLaVa (Large Language and Vision Assistant), see, e.g., Liu, Haotian, et al. “Visual instruction tuning.” arXiv preprint arXiv:2304.08485 (2023). This is a novel end-to-end trained large multimodal that combines a vision encoded and Vicuna for general purpose visual and language understanding (Vicuna is a chat assistant trained by fine0tuning LLaMA on user-shared conversation collected from ShareGTP, see, e.g., Zheng, Lianmin, et al. “Judging LLM-as-a-judge with MT-Bench and Chatbot Arena.” arXiv preprint arXiv:2306.05685 (2023), the contents of which are incorporated by reference in their entirety).
(4) BART (Bidirectional and Auto-Regressive Transformers) zero-shot classifier. BART is pre-trained by (1) corrupting text with an arbitrary noising function, and (2) learning a model to reconstruct the original text. Zero-shot classification is a machine learning approach in which a model can classify data into multiple classes without any specific training examples for those classes.
(5) CLIP (Contrastive Language-Image Pretraining), see, e.g., Radford, Alec, et al. “Learning transferable visual models from natural language supervision.” International conference on machine learning. PMLR, 2021, the contents of which are incorporated by reference in their entirety. CLIP can predict the most relevant text snippet in a given image.

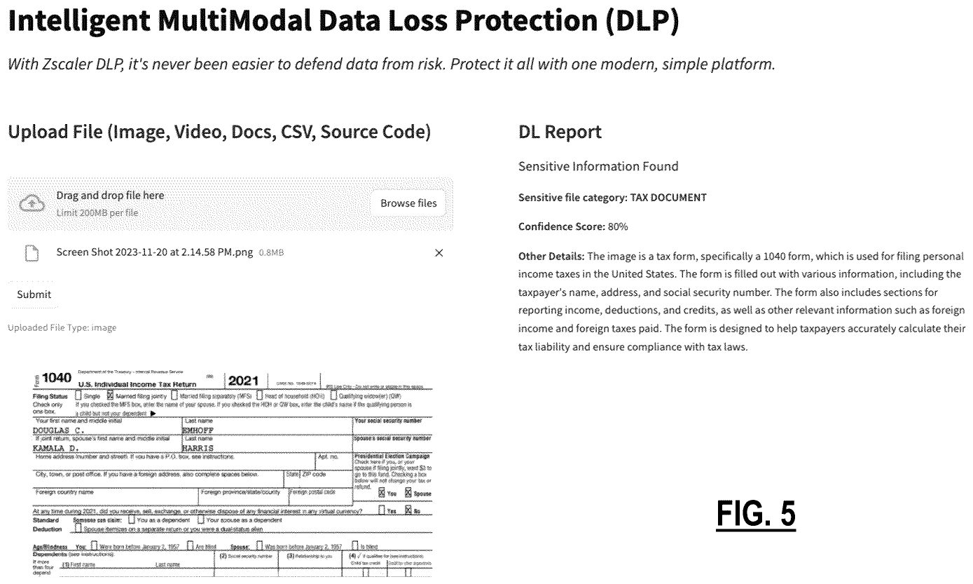

FIG. 5 is a screenshot of an example output of the multimodal DLP system 400. FIG. 5 is presented for illustration purposes and those skilled in the art will appreciate the output can be used in the cloud 120, in any of the network configurations 100A, 100B, 100C, and the like, for various purposes, including allowing/blocking content, providing notifications and alerts, crawling cloud services for detection, etc. Here, a single file is input (e.g., image, video, docs, CSV, source code, etc.) and the tools 404 analyze the file, e.g., in this case an image—a screenshot in the form of a Portable Network Graphic (PNG) file. The output includes a classification that the information is (1) sensitive and (2) in a category or super category of a Tax document, along with a confidence score (e.g., 80%), as well as with other details, such as derived from the LLMs 410.

### § 4.3 Multimodal DLP with Artificial Intelligence Process

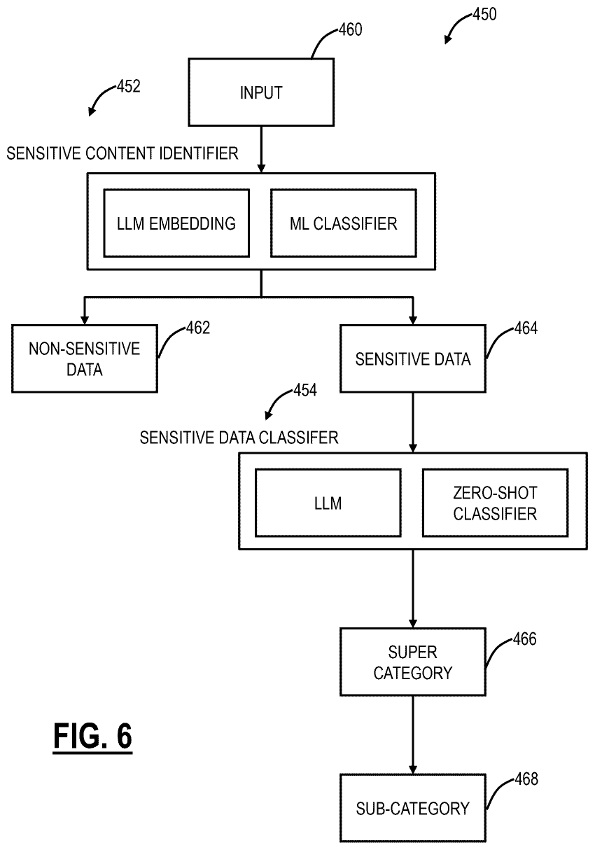

FIG. 6 is a flowchart of a multimodal DLP with artificial intelligence process 450. The process 450 contemplates implementation as a method having steps, via computing resources configured to implement the steps, and as a non-transitory computer-readable medium with instructions that when executed cause one or more processors to implement the steps. The process 450 can be implemented with the multimodal DLP system 400, and practical implementations of the multimodal DLP system 400 and the process 450 can be through the network configurations 100A, 100B, 100C, and the like. That is, the multimodal DLP system 400 and the process 450 contemplate use with any cybersecurity monitoring platform, appliance, service, etc.

The process 450 is implemented via a two-stage classifier including a sensitive content identifier step 452 and a sensitive data classifier step 454. The process 450 uses the two steps to improve the detection of sensitive data and enhance the user experience. The process 450 begins with an input (step 460). Again, the input can be some content in any file format, as well as in a combination of formats. The sensitive content identifier step 452 determines if the input has sensitive data, emphasizing precision and recall for the sensitive category to reduce false positives and false negatives. The sensitive content identifier step 452 can include use of LLM embeddings and a machine learning classifier to determine whether or not the input is sensitive (step 464) or not (step 462). The LLM embeddings are used to detect and classify objects in the inputs and the machine learning classifier can be used to classify text along with the objects. Of course, the process 450 can terminate upon determination the input is not sensitive (step 462), i.e., there is no potential data loss. As such, the sensitive content identifier step 452 enables quicker and more efficient detection.

The sensitive data classifier step 454 only needs to be performed when the input is sensitive. The sensitive data classifier step 454 organizes sensitive information into predefined categories to enhance the user experience and for reporting. For example, the sensitive data classifier step 454 can determine a super category (step 466) as well as a sub-category (step 468). For example, the super category can be financial, engineering, marketing, sales, human resources, tax, etc., i.e., a larger classification. The sub-category can be different for each super category, e.g., for financial—invoice, purchase order, purchase agreement, financial statement, bill of sale, loan agreement, etc., and the like.

The two steps 452, 454 can be used with various cybersecurity monitoring approaches. The sensitive content identifier step 452 can be a front end and in testing has shown accuracy of more than 90%. In the case of data in transit, the sensitive content identifier step 452 can be used to block/allow files. In the case of data at rest, the sensitive content identifier step 452 can be used to efficiently identify and further process sensitive data, i.e., the full detection is not needed on non-sensitive data. The sensitive data classifier step 454 can be used by IT for policy. The two steps 452, 454 can use various combinations of the tools 404, including the example machine learning models described above.

The following table provides some metrics associated with an implementation of the process 450:

| Model | precision | recall |
|---|---|---|
| Sensitive content detector | 0.95 | 0.98 |
| Sensitive data categorizer (super-category) | 0.84 | 0.85 |
| Sensitive data categorizer (sub-category) | 0.78 | 0.73 |

### § 4.4 Image Data De-Noising and Cleaning Algorithm for Image Classification

Both the steps 452, 454 can utilize machine learning models for image classification. In an embodiment, the present disclosure includes various techniques to enhance image data cleanliness and improve quality for tasks related to image classification. These techniques can be used with any image-based file format 402, tool 404 used to process images, and the steps 452, 454. It encompasses three aspects, which can be used together or individually, including OCR, file size filtering, and image hashing.

### § 4.4.1 OCR

OCR includes converting any text in images to a computer-readable text format, i.e., typed, handwritten, or printed text in images or video screenshots into machine-encoded text. For example, PDF documents can be image-based, but represent text documents. Conventionally, OCR is used to convert images to text and then the text is processed through DLP dictionaries. See, e.g., commonly-assigned U.S. Pat. No. 11,805,138, issued Oct. 31, 2023, and entitled “Data Loss Prevention on images,” the contents of which are incorporated by reference in their entirety. The present disclosure contemplates OCR with the multimodal DLP system 400 for enhancing processing and/or for improving efficiency, speed, etc.

In an embodiment, OCR can be used in training machine learning models. As is known in the art, supervised learning involves a training process where a machine learning model is trained with labeled samples. After training, the machine learning model is able to perform inferences or classifications in production. In the multimodal DLP system 400, one or more machine learning models can be used in the sensitive content identifier step 452 to classify an image as sensitive or not, and in the sensitive data classifier step 454, to classify an image into one of a plurality of super categories as well as into one or more sub-categories.

For both these tasks, classifying as sensitive/non-sensitive and for categories, there is a requirement for training data which is labeled. For example, a first set of documents each labeled as either sensitive or not, and a second set of documents labeled for categories (of course, this second set of documents can be the same as the first set, different, or include some of the same images). A key aspect of this training is that is does not require individual companies to provide their sensitive information. Rather, the trained machine learning models are trained across a whole set of the documents such as from public repositories, from the model creator, etc.

For example, the model creator can use its own internal documents for training. The model creator can be a SaaS provider, cloud service provider, etc., and has a large amount of internal documents and these are already labeled. The model creator can get documents from finance, HR, sales, engineering, etc. and those labels can be attached for the categories. In other embodiments, labeling for training documents can be performed using other machine learning techniques such as clustering, etc.

In an embodiment, OCR can be used to identify mislabeled samples in either or both of the first set or second sect of training documents. Here, the text can be extracted from labeled sample images and then verified against keywords associated with sensitive data categories. For example, examine whether the extracted text contains words such as ‘property,’ ‘asset,’ ‘seller,’ ‘buyer,’ or ‘purchase agreement’ for real estate documents. This can be extended to all of the super categories and the sub-categories in the sensitive data classifier step 454. An output of this OCR can be a suspect set of training documents that can be provided for user input. Output from this can be used to further refine the keywords as well as to relabel any of the suspect set of images.

OCR can also be used in the sensitive content identifier step 452. In an embodiment, classification of sensitive/non-sensitive can be performed in combination with categorization classification. For example, all HR documents are sensitive, etc. In another example, the classification of sensitive/non-sensitive can be performed in with a separate model from the categorization classification. In either case, the OCR can be used to identify mislabeled samples at for the classification of sensitive/non-sensitive. Here, there is a large pool of words for sensitive and non-sensitive.

A key aspect of this technique is it improves the training of the models for classification as the input data is cleaner with respect to labels.

### § 4.4.2 File Size Filtering

In various embodiments, the present disclosure can include a technique of filtering out images that are blurry, unreadable, etc. This filtering technique can be performed both the in first or second set of documents for training as well as in any inputs being analyzed in production by the multimodal DLP system 400. In particular, filtering can be performed based on file size or image resolution. Smaller image files are often blurry and challenging to visualize.

In the training data, the file size filtering can be used to exclude poor images from the first or second set of documents for training. In production, the file size filtering can be used exclude images from processing by the multimodal DLP system 400 where there is no risk due to the image not having any discernible content. In training, this approach improves the quality of the training data, and, in production, this approach improves the efficiency and resource cost of the multimodal DLP system 400.

### § 4.4.3 Image Hashing

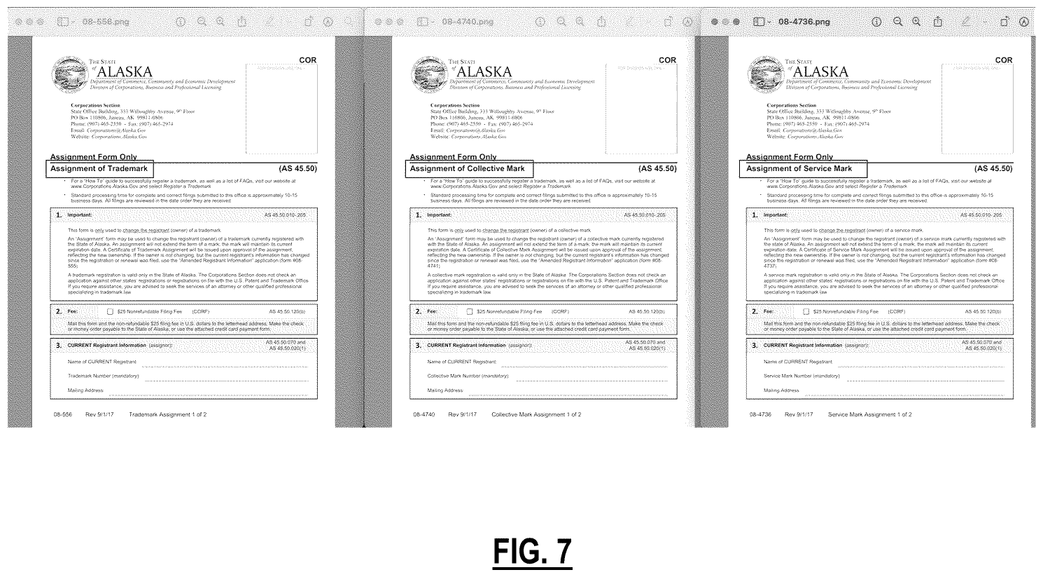

Also, the present disclosure can include imaging hashing which can detect identical or closely similar images in the training data, i.e., the first or second set of training data, and eliminate duplicates. FIG. 7 is a screenshot of three sample images that are closely similar to one another. In particular, these three sample images are government documents for Assignment of Trademark, Collective Mark, or Service Mark. That is, the highlighted portion in FIG. 7 shows the only difference between these three documents, i.e., the words Trademark, Collective Mark, or Service Mark before “Assignment of.” With image hashing, these three documents are detected as being closely similar to one another, and these three samples are grouped together as they exhibit high similarity with only subtle differences. To prevent data leakage issues, it's advisable to retain only one of them in the training data. In an embodiment, the imaging hashing can utilize ImageHash, available at pypi.org/project/ImageHash/.

### § 4.4.4 Data Cleaning

For the training data, the present disclosure can utilize the various approaches described herein for data cleaning. Some additional approaches for data cleaning on image files include removing observed duplicates as described above, removing logos, removing front pages or guidance (instruction) pages, and the like.

### § 4.5 Combination of LLM and Zero-Shot Classifier

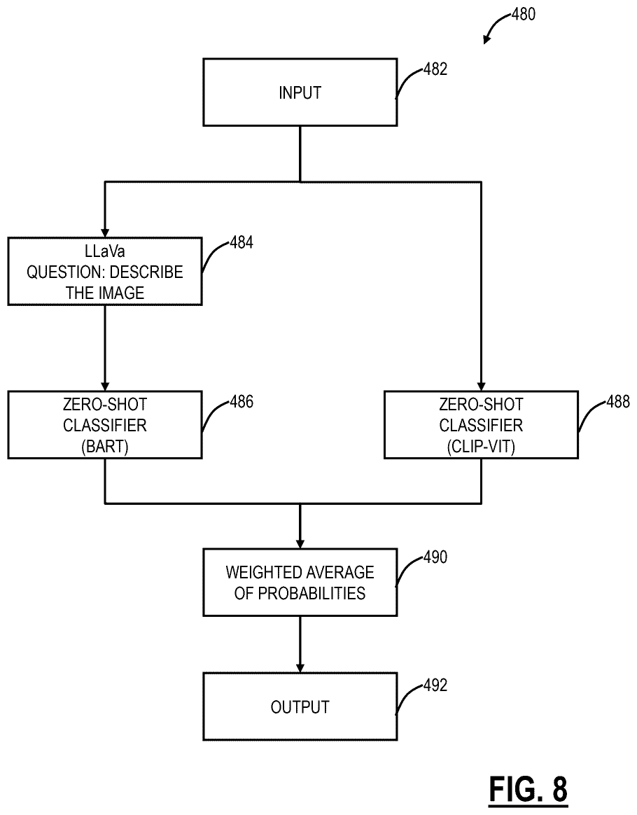

FIG. 8 is a flowchart of a process 480 for an example implementation of the sensitive data classifier step 454 using a combination of an LLM and zero-shot classifiers. The process 480 contemplates implementation as a method having steps, via computing resources configured to implement the steps, and as a non-transitory computer-readable medium with instructions that when executed cause one or more processors to implement the steps. The process 480 can be implemented with the multimodal DLP system 400, and practical implementations of the multimodal DLP system 400 and the processes 450, 480 can be through the network configurations 100A, 100B, 100C, and the like. That is, the process 480 contemplates use with any cybersecurity monitoring platform, appliance, service, etc.

The process 480 includes receiving an input (step 482) and both:
(1) processing the input with an LLM to describe the image (step 484) and processing the description with a zero-shot classifier (step 486). For example, LLaVa can be used as the LLM to describe the image and BART can be used as the zero-shot classifier.
(2) processing the input with a zero-shot classifier, such as CLIP-VIT (step 488).

The process 480 includes taking outputs of the two zero-shot classifier steps 486, 488, assigning a weighted average (step 490), and providing an output classification (step 492).

### § 4.6 Combination of CLIP Embedding and Supervised Learning Xgboost

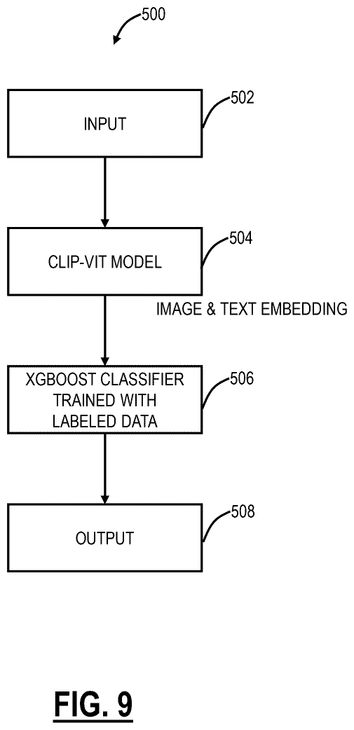

FIG. 9 is a flowchart of a process 500 for an example implementation of the sensitive content identifier step 452 using a combination of CLIP embedding and supervised learning XGboost. The process 500 contemplates implementation as a method having steps, via computing resources configured to implement the steps, and as a non-transitory computer-readable medium with instructions that when executed cause one or more processors to implement the steps. The process 500 can be implemented with the multimodal DLP system 400, and practical implementations of the multimodal DLP system 400 and the processes 450, 480, 500 can be through the network configurations 100A, 100B, 100C, and the like. That is, the process 500 contemplates use with any cybersecurity monitoring platform, appliance, service, etc.

The process 500 includes receiving an input (step 502), processing the input with a CLIP-VIT model (step 504) to obtain image and text embeddings, processing the image and text embeddings with an XGboost classifier that was trained with labeled data (step 506), and providing an output (step 508).

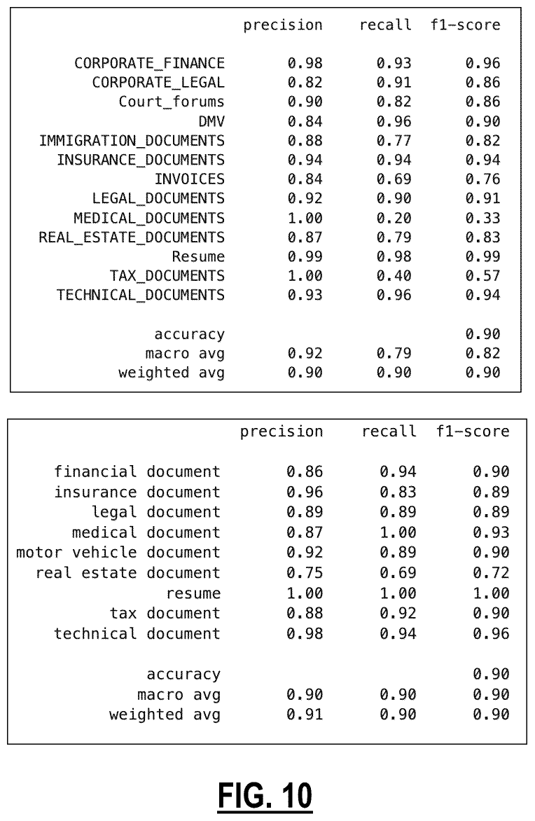

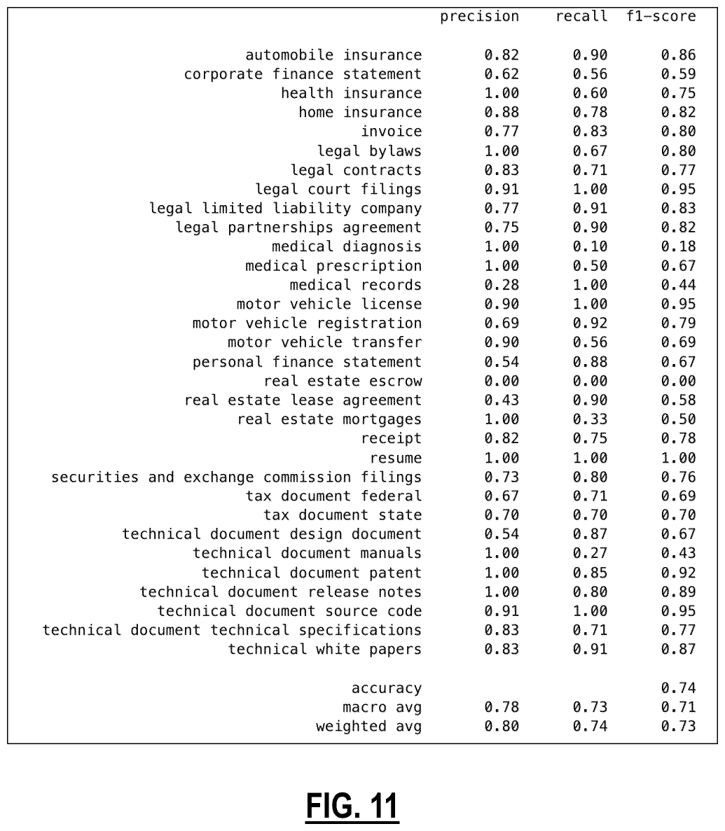

FIG. 10 is a table of examples of categorization results using the process 500. Here, the process 500 is configured to categorize the input into one of 13 categories, e.g., finance, legal, etc. Note, the high values for both precision and recall. FIG. 11 is a table of examples of sub-category results.

In various embodiments, the following models were used herewith:

| task | model |
|---|---|
| Content extraction | LLaVa |
| | LLaVa + RAG |
| | BLIP |
| | Video-LLaMA |
| | OCR |
| Embedding | TF-IDF |
| | Bert |
| | Clip-Vit |
| Classification | Bart zero-shot classifier |
| | Clip-Vit zero-shot classifier |
| | XGboost |

### § 4.7 Latency Reduction of LLMs by Model Compression

The following table illustrates some example models, associated performance, and cost, for implementing the sensitive data classifier step 454. LLAVA+Zero Shot method uses pre-trained model to do classification. Clip Base/Large method does embeddings. Then we split data into train/test and build ML classifier with the embedding feature vectors.

| | | | Accuracy | Accuracy | | |
|---|---|---|---|---|---|---|
| | Time to | | (in %) | (in %) | Prediction | Dollar |
| | load (in | | Train:Test | Train:Test | Time (in | cost (per |
| Model | secs) | Memory (in Gb) | 8:2 | 2:8 | secs) | image) |
| LLAVA + Zero Shot | 40 | 29 | 65 | 65 | 12.5 | $0.01 |
| Clip Base | 1.8 | 3.2 | 77 | 70 | 0.074 | $0.00007 |
| Clip Large | 3.5 | 3.6https://clip-as- | 90 | 85 | 0.1 | $0.0001 |
| | | service.jina.ai/user- | | | | |
| | | guides/benchmark/ | | | | |

### § 4.8 Multimodal DLP Process

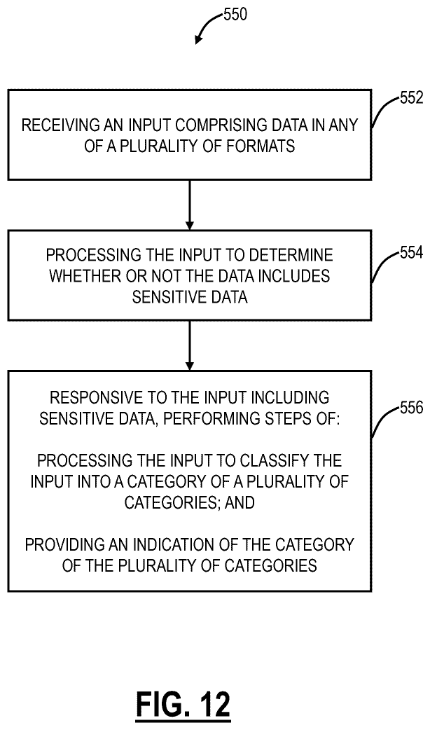

FIG. 12 is a flowchart of a process 550 for multimodal DLP. The process 550 contemplates implementation as a method having steps, via computing resources configured to implement the steps, and as a non-transitory computer-readable medium with instructions that when executed cause one or more processors to implement the steps. The process 550 can be implemented with the multimodal DLP system 400, and practical implementations of the multimodal DLP system 400 and the processes 450, 480, 500 550 can be through the network configurations 100A, 100B, 100C, and the like. That is, the process 550 contemplates use with any cybersecurity monitoring platform, appliance, service, etc.

The process 550 includes receiving an input comprising data in any of a plurality of formats (step 552); processing the input to determine whether or not the data includes sensitive data (step 554); and responsive to the input including sensitive data, performing steps of: processing the input to classify the input into a category of a plurality of categories; and providing an indication of the category of the plurality of categories (step 556).

The process 550 can further include, responsive to the input including non-sensitive data, providing an indication the data is non-sensitive, thereby either allowing the data in transit or not marking the data at rest. The process 550 can further include, responsive to the input including sensitive data, providing an indication of the category of the plurality of categories and a sub-category associated with the category.

The plurality of formats can include text formats, image formats, audio formats, video formats, source code, and a combination thereof. The processing the input to determine whether or not the data includes sensitive data can utilize (1) a Large Language Model (LLM) and embeddings and (2) a machine learning model configured for classification. The processing the input to classify the input into the category can utilize (1) a Large Language Model (LLM) and (2) a zero-shot classifier.

The processing the input to determine whether or not the data includes sensitive data and the processing the input to classify the input into the category both can utilize one or more machine learning models that were trained based on a set of training documents with labels. The process 550 can further include, prior to training the one or more machine learning models with the set of training documents with labels, identifying any mislabeled documents therein by performing Optical Character Recognition (OCR) and checking if associated keywords are present. The process 550 can further include, prior to training the one or more machine learning models with the set of training documents with labels, filtering out an images in the set of training documents with labels based on file size. The process 550 can further include, prior to training the one or more machine learning models with the set of training documents with labels, grouping images in the set of training documents with subtle differences based on a hash of the images.

### § 4.9 Multimodal DLP and Conventional DLP

The present disclosure presents various approaches for multimodal DLP with artificial intelligence. These techniques can be used in combination with existing DLP detection techniques, such as ones with DLP dictionaries. In an embodiment, the conventional DLP techniques can be used with the multimodal DLP with machine learning, to provide two answers which can be combined to give a final, more reliable answer (sensitive or not). In another embodiment, the multimodal DLP with machine learning and the conventional DLP techniques can be used to front end one another, i.e., either way, to reduce computational effort. For example, the sensitive content identifier step 452 can be used as a front end classifier to determine whether given content needs to be analyzed further, such as with DLP dictionaries, for improving efficiency and latency of DLP monitoring.

### § 4.10 Categorization

Conventional DLP approaches work by detecting specific pre-defined content whereas the approach described herein provides a classification and/or categorization of content. As described herein, the multimodal DLP with artificial intelligence process 450 can perform a classification with the sensitive content identifier step 452 that data is either sensitive or non-sensitive, and the sensitive data classifier step 454 can perform categorization into one of a plurality of categories. Advantages of this approach include the ability to detect classes and categories of documents without a need to provide sensitive data up-front, as well as improved accuracy, less false negatives or positives, and the like.

The categorization can be based on training as described herein. In an embodiment, the training can be performed by an entity hosting the model, referred to as a model creator. The model creator can use its own internal documents as well as publicly available documents in order to eliminate the need for companies to expose their sensitive documents. Specifically, the models are training on types of documents as opposed to specific content. In an embodiment, the categories can include immigration documents, corporate legal documents, court documents, legal documents, tax documents, insurance documents, invoice documents, resume documents, real estate documents, medical documents, technical documents, and finance documents. Of course, other categories are possible, based on the training data and associated labels. That is, the number of labels determines the number of categories. Further, an “others” category classification can exist for files/content that does not fall within the various categories.

### § 4.11 DLP Rules and Analytics

Again, the approach described herein can be used in combination with conventional DLP techniques, i.e., using dictionaries. This can enable a holistic approach for DLP monitoring in cybersecurity. Specifically, IT can gain insight into activity and spot issues where there are disconnects between data handling based on user function, in addition to stopping specific data from being exposed. With categories, DLP rules can be more than a single document contains sensitive information. Rather, there can be policies where someone's function is compared to their activities, e.g., someone in engineering should not be handling a large volume of HR documents and vice versa.

### § 4.12 Inline Multimodal DLP

The present disclosure provides various methods for streamlining the multimodal Data Loss Protection (DLP) processes described herein for better utilization in an inline manner. These methods are designed to enhance the efficiency and effectiveness of DLP systems that handle multiple types of data, such as text, images, audio, etc. Key aspects of these methods include optimizing data flow to ensure efficient management and protection of data from various sources without causing bottlenecks or delays and reducing processing latency through advanced algorithms to speed up data processing and threat detection. Enhanced real-time inference enables the DLP system to make quicker and more accurate classifications, ensuring immediate protection against data breaches and leaks, which is particularly important for inline applications where data needs to be protected as it is being transmitted or used. Improved preprocessing steps ensure that data is properly formatted and ready for analysis by the DLP system, with techniques for handling different data formats and ensuring data integrity before processing. Additionally, methods for training and adapting DLP models are included to recognize and protect against new and evolving threats, ensuring the system remains effective over time and can handle a wide variety of data types and scenarios. These methods are designed to integrate seamlessly with existing systems and workflows, allowing organizations to implement advanced DLP capabilities without significant disruption or overhaul of their current infrastructure. By focusing on these areas, the present disclosure aims to provide a comprehensive and effective approach to multimodal DLP, enabling better protection of sensitive data in a wide range of real-world applications.

In addition to the models (1)-(5) described above, the use of the BERT model is contemplated in various embodiments. BERT or Bidirectional Encoder Representations from Transformers created new benchmarks in multiple NLP tasks. This was due to the bidirectional nature of contextual understanding. The model, besides using text preprocessing, also tries to capture meaning from unseen words using WordPiece Tokenizer, making it a go-to choice for even noisy data. Again, as described herein, the various models used by the present systems can be trained with specific data, or be pre-trained. The various modifications described herein can then be made to the models utilized by the systems.

In various embodiments, the present inline multimodal DLP techniques include modifying one or more models to reduce latency while retaining prediction accuracy. This is referred to herein as one or more modifications to the models used in the present multimodal DLP system described herein. The various modifications are further described herein with provided test results.

In various embodiments, one modification can include reducing a models vocabulary. For example, the BERT Tiny model vocabulary can be simplified in order to reduce latency. Further, introducing file size thresholds can further reduce latency while retaining prediction accuracy. For image and text classification, the BERT Tiny model can be fine-tuned for text classification, while the Vision Transformer (ViT) Tiny model can be fine-tuned for image classification. Such models can further be utilized in a composite manner as further described herein.

As stated, the various models described herein can be simplified with one or more modifications to reduce latency and retain prediction accuracy. Such methods are employed to speed up text pre-processing without sacrificing the prediction accuracy. These methods include the aspects of removing, from the model's vocabulary, non-English words, removing stop words, and lemmatization, i.e., reducing words to their root form. The following table illustrates the impact of such methods on a model's prediction accuracy, the example model being the BERT model.

| | | BERT (with reduced |
|---|---|---|
| | BERT | vocabulary) |
| Prediction accuracy | 69% | 71% |
| Vocabulary file | 30,522 words | 12,760 words |

Additionally, in various embodiments, to further reduce latency while retaining prediction accuracy, the methods can include modifying a model by enforcing lower and upper text-byte thresholds and text processing stopping points. A lower text-byte threshold can be employed to cause the model to skip files below this threshold and classify them as miscellaneous or “other”. An upper text-byte threshold can be enforced to cause a model to extract only up to this specified amount of text for input into the prediction model. Finally, a defined early stopping k value determines the stopping point for text processing and vocabulary mapping iterations. That is, this innovative approach can be employed to speed up the text vocabulary mapping by only iterating k tokens. The following table shows iteration times associated with a plurality of file types and a plurality of specified early stopping k values.

| | Processing time | | Processing time | | Processing time | |
|---|---|---|---|---|---|---|
| File | with no optimization | | with k = 1000 | | with k = 500 | |
| Unicode, 105,801 | 12.20913333 | (ms) | 0.205729 | (ms) | 0.1269013333 | (ms) |
| Emojis, 85,021 | 8.64395 | (ms) | 0.149041 | (ms) | 0.112933 | (ms) |
| Quaran, Arabic, | 187.1666667 | (ms) | 0.1434073333 | (ms) | 0.1022473333 | (ms) |
| 2,157,401 words | | | | | | |
| Don Quie Hote, | 1.498093333 | (ms) | 0.6082473333 | (ms) | 0.3971176667 | (ms) |
| Spanish, | | | | | | |
| 1,877,151Words | | | | | | |
| Bhavagad Gita, | 18.8027 | (ms) | 0.1797483333 | (ms) | 0.1377733333 | (ms) |
| Sanskrit, | | | | | | |
| 13,011,401 words | | | | | | |

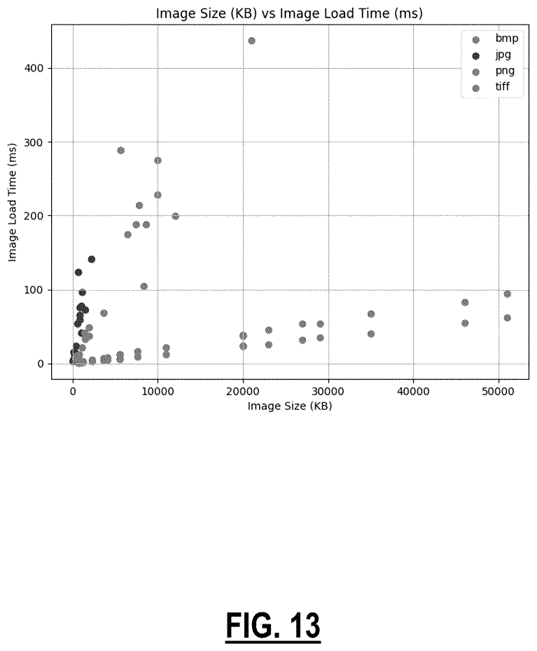

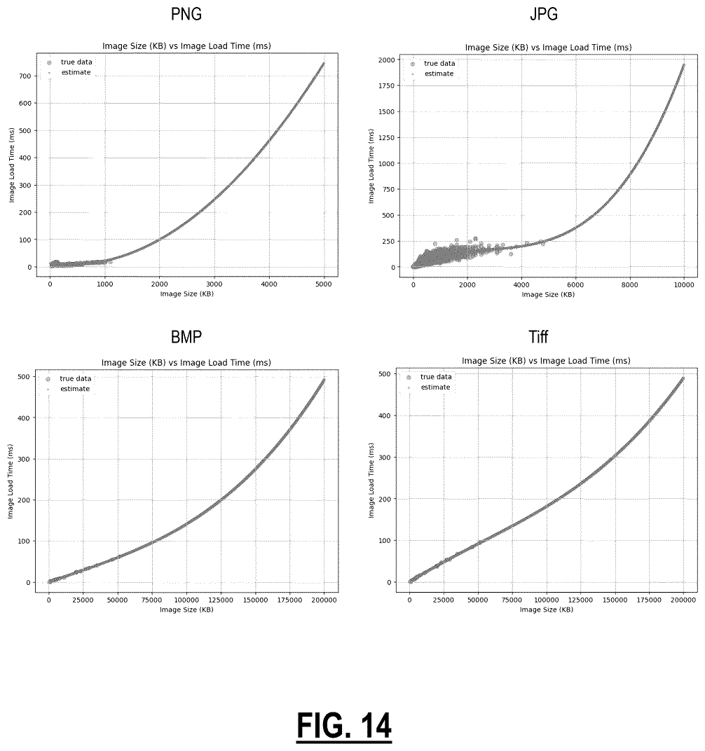

Further, in various embodiments, for image processing models such as ViT and the like, an input file size maximum can be enforced to control latency. These methods include the utilization of polynomial regression to predict a trend and estimate the thresholds. This is necessary because different image file types incur different load times. FIG. 13 is a diagram representing image size vs load time for a plurality of image file types. As can be seen, load times are not directly related to image size across different image file types. FIG. 14 shows a plurality of estimated load time vs image size trends for various image file types, the estimated load time vs image size trends being determined based on polynomial regression or other methods of the like. Based on these trends, the thresholds can be determined and enforced for each image file size based on image file type. For example, an image file size threshold can be enforced, where an image file having a size above a determined threshold will not be processed. Again, this threshold can be based on the image file type as described because of the different load time characteristics associated with each of the various image file types. That is, the thresholds can be based on a set load time, where the file size threshold can be determined from the estimated trends for each image file type.

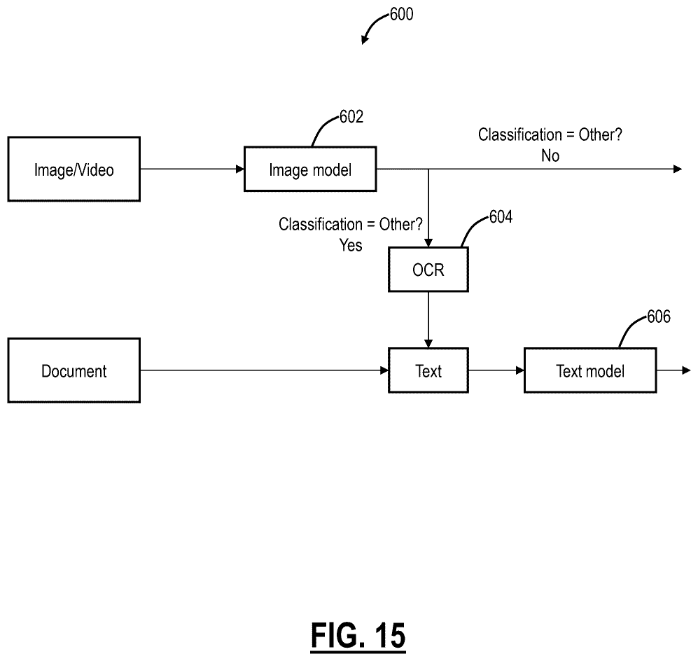

Further, in various embodiments, a composite text and image classification method is contemplated. More specifically, a composite BERT and ViT model architecture is utilized for more efficient text and image classification. FIG. 15 is a flow diagram of a composite text and image classification architecture 600. The composite text and image classification architecture 600 shown in FIG. 15 operates based on a classification generated by an image model 602. If the image model produces a classification prediction of “other” the image will be passed to an OCR engine 604 and then text will be extracted, and subsequently processed by the text model 606. For text based documents, text will be fetched directly and passed to the text model 606. This will allow it to leverage high accuracies of individual models, customize post processing steps of each model, and decrease OCR calls by categorizing image data first.

As described, the image model 602 shown in FIG. 15 can include the ViT model while the text model 606 can include the BERT model described herein, although, the composite architecture can be utilized with any model described herein for text and image processing. Further, these models can include any of the modifications described in the present disclosure for reducing latency while retaining accuracy of classifications.

As stated, the inline multimodal DLP systems can be utilized for production data inline. That is, through the network configurations 100A, 100B, 100C, and the like for processing data flowing through the cloud 120, i.e., as part of the inline monitoring described herein.

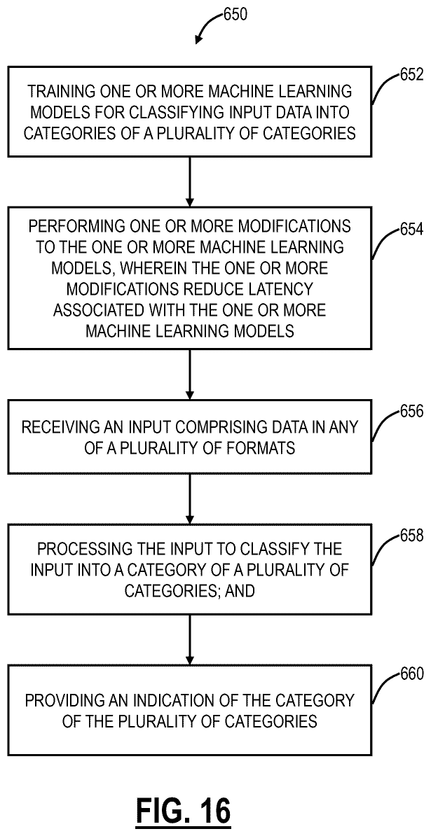

FIG. 16 is a flowchart of a process 650 for inline multimodal DLP. The process 650 contemplates implementation as a method having steps, via computing resources configured to implement the steps, and as a non-transitory computer-readable medium with instructions that when executed cause one or more processors to implement the steps. The process 650 can be implemented with the multimodal DLP system 550, 400, and practical implementations of the multimodal DLP system 400 and the processes 450, 480, 500 550 can be through the network configurations 100A, 100B, 100C, and the like. That is, the process 650 contemplates use with any cybersecurity monitoring platform, appliance, service, etc.

The process 650 includes training one or more machine learning models for classifying input data into categories of a plurality of categories (step 652); performing one or more modifications to the one or more machine learning models, wherein the one or more modifications reduce latency associated with the one or more machine learning models (step 654); receiving an input comprising data in any of a plurality of formats (step 656); processing the input to classify the input into a category of a plurality of categories (step 658); and providing an indication of the category of the plurality of categories (step 660).

The process 650 can further include wherein the one or more modifications include any of removing, from the one or more machine learning model's vocabulary, non-English words, removing stop words, and performing lemmatization. The one or more modifications can include any of enforcing a lower text-byte threshold, an upper text-byte threshold, and an early stopping k value. The one or more modifications can include enforcing an input file size maximum. The input file size maximum can be based on a file type of the input. The input file size maximum can be determined based on one or more estimated load time vs image size trend graphs. The one or more machine learning models can include an image classification model and a text classification model, and wherein the steps further include: responsive to the image model producing a classification prediction of “other”, extracting text from the image via an Optical Character Recognition (OCR) engine; and processing the extracted text via the text classification model. The steps can further include processing the input to determine whether or not the data includes sensitive data prior to processing the input for classification. The plurality of formats can include text formats, image formats, audio formats, video formats, source code, and a combination thereof. The steps can further include, prior to training the one or more machine learning models with the set of training documents with labels, identifying any mislabeled documents therein by performing Optical Character Recognition (OCR) and checking if associated keywords are present.

### § 5.0 Inline Nested DLP

The present disclosure establishes systems and methods for implementing nested Data Loss Prevention (DLP) classification, offering improved capabilities for organizing and protecting sensitive information through innovative techniques. These advancements aim to enhance accuracy, efficiency, and scalability in modern data classification systems. Various embodiments of the disclosed methodologies include a plurality of innovations.

In various embodiments, advanced web scraping systems are used to collect diverse data from various online sources while adhering to ethical data practices. Additionally, synthetic data generation powered by LLMs enables the creation of high-quality datasets for model training, testing, and validation. By synthesizing data that mirrors real-world scenarios, the system enhances its robustness, ensuring greater applicability across multiple domains. These approaches expand the versatility of data collection, making it possible to address specific DLP needs in dynamic environments.

A streamlined data labeling pipeline is introduced, wherein LLMs are utilized to automatically assign hierarchical labels to datasets, including super-category, sub-category, and granular-category classifications. This automation reduces manual intervention and enhances the consistency and accuracy of label assignments. The model-driven pipeline is capable of understanding complex relationships between categories, enabling scalable handling of vast datasets and finer granularity for nested DLP classification.

The system further incorporates hierarchical modeling to predict and organize text documents within a multi-level framework. Using advanced methods, it captures intricate relationships between categories and subcategories to establish a well-structured classification hierarchy. This innovation facilitates more accurate and granular prediction of sensitive content, ensuring better alignment with DLP requirements. The hierarchical framework significantly improves the interpretability of predictions, offering actionable insights for data protection strategies.

To address issues of overconfidence in predictive models, the system applies label smoothing techniques. By moderating the sharpness of probability distributions associated with predicted labels, the risk of false positives and negatives is reduced, yielding more reliable classification outcomes. This technique enhances the robustness of nested DLP frameworks, ensuring that predictions remain well-calibrated and adaptable across varying levels of data complexity.

Together, these methods enable dynamic, scalable, and high-quality data collection pipelines tailored for nested DLP classification tasks, laying the foundation for improved accuracy and robustness in sensitive data organization and prediction. The integration of web scrapers with synthetic data generation ensures holistic data representation across varied use cases.

The data collection process leverages a combination of automated web scrapers and synthetic data generation powered by Large Language Models (LLMs) to ensure comprehensive and scalable acquisition of diverse datasets, addressing challenges related to data availability in specific domains. The web scrapers are designed and implemented to automatically navigate source web pages and their nested sub-pages, enabling seamless extraction of structured and unstructured data. These scrapers locate and download specific file types such as PDFs, DOCX, JPGs, PNGs, and others, ensuring targeted retrieval of relevant information. Additionally, the scrapers are highly configurable, mimicking manual data download processes and adapting to the unique structures of various websites. They are equipped to handle advanced web designs such as pagination and infinite scrolling, ensuring dynamic and scalable interaction with websites that employ complex navigation techniques.

To complement the data collected through web scraping, synthetic data generation using LLMs addresses scenarios where obtaining sufficient data for particular categories is challenging. By either generating synthetic data directly or constructing it from the downloaded datasets, this approach creates high-quality data that mirrors real-world characteristics and introduces variability for improved model generalization. The use of LLMs ensures robust data augmentation, filling gaps in data availability and providing balanced datasets for training and evaluation. This integrated system of automated web scraping and LLM-powered synthetic data generation forms the backbone of a dynamic and flexible data collection pipeline tailored for nested DLP classification tasks. It ensures scalable, diverse, and high-quality datasets to enhance model accuracy and robustness in sensitive data organization and prediction.

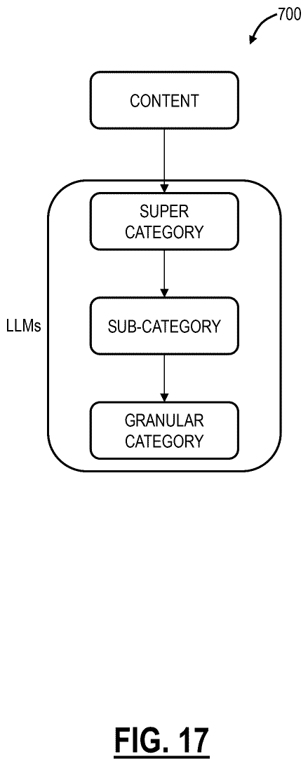

FIG. 17 is a flow diagram of a data labeling pipeline. The data labeling pipeline 700 introduces an automated hierarchical labeling system powered by Large Language Models (LLMs) to efficiently classify data into super-category, sub-category, and granular-category labels. This process eliminates the need for manual annotation, ensuring scalability, consistency, and accuracy in data classification. The hierarchical structure of the pipeline is designed to systematically refine the categorization based on dynamic prompts at each level.

Starting with a super-category classification, the system uses a pre-defined list of sub-category prompts corresponding to the identified super-category. Once the sub-category is determined, the pipeline further refines the categorization by using a granular-category list prompt associated with the selected sub-category. This progressive narrowing of labels ensures that the data is classified with increasing specificity and granularity. LLMs drive this process by leveraging their contextual understanding to accurately interpret relationships between hierarchical labels, automatically generating classifications aligned with the nested structure.

This labeling pipeline enhances the efficiency and precision of hierarchical data categorization, offering a scalable solution for complex nested classification tasks. By utilizing LLMs at each stage, the system ensures seamless transitions across super, sub, and granular categories while minimizing errors and inconsistencies in label assignments.

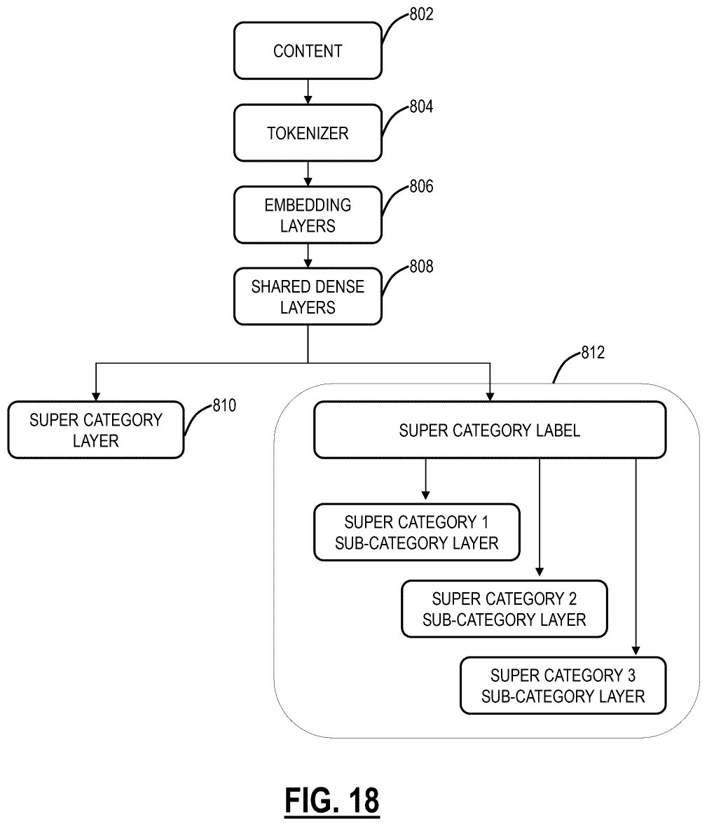

FIG. 18 is a flow diagram of a model training process. The model training process begins with the ingestion of input content 802 using a tokenizer 804, such as the Bert-tiny tokenizer, which converts raw input data into a format that is readable and processable by the model. This tokenized input then passes through various embedding layers 806 and shared dense layers 808, which perform dimensional reduction to create compact yet meaningful representations of the input data. Based on these reduced representations, the training process progresses into determining the super-category of the input via a dedicated super-category layer 810. Traditionally, such systems are designed to categorize data into approximately 14 distinct super-categories, which encompass broad classifications such as legal documents, medical documents, financial documents, and other high-level categories relevant to nested classification tasks. The identification of the super-category leads to the computation of a main loss based on the model's outputs.

Building upon the super-category identification, the system further classifies the data into sub-categories through various sub-category layers 812 and subsequently refines the classification down to granular categories, representing the finest level of detail in the hierarchical structure. Additional outputs from these nested layers enable the computation of a sub-loss, which reflects the accuracy and quality of predictions at the sub-category and granular category levels.

The training process benefits from a targeted approach, as demonstrated by the figure showing three example samples from the super-category training process. Following the assignment of super-categories to the samples, the system intelligently feeds them through various layers pertinent to the identified super-category. Ground truth super-category samples are used to train the sub-category and granular category layers by computing losses for these layers. These computed losses are then back-propagated through the model, such as the Bert-tiny model, to update its weights and improve classification performance.

One of the key innovations of the described system lies in its ability to dynamically enable only the specific sub-layers associated with the super-category assigned to each sample. By restricting processing to relevant sub-layers, the system significantly lowers computational costs and accelerates the training process. This efficiency ensures that nested classification tasks are performed faster and more effectively, while maintaining high accuracy across all hierarchical levels, from super-categories to granular categories.

The nested model inference process is designed to perform hierarchical predictions, enabling the identification of both super-categories and sub-categories for a given input sample. This approach uses a probabilistic structure, leveraging logits (output scores) to systematically determine the categories with the highest probabilities at each level of classification. The process begins by analyzing the logits to identify the super-category with the highest probability, establishing the first level in the hierarchical classification. Once the super-category is determined, the model narrows its focus to the logits associated specifically with the sub-categories within that super-category and selects the sub-category with the highest probability, thereby refining the predictions to the second hierarchical level.

For example, in one scenario, the model predicts the super-category as “Legal Documents” for an input sample and subsequently classifies the sub-category within this group as “Bills_of_Sale.” For another sample, it assigns the same super-category, “Legal Documents,” but further refines the classification to “Investment_Agreements.” Similarly, when presented with a sample predicted to belong to the super-category “Medical Documents,” the system further identifies the sub-category as “Disease_Information.” This step-by-step approach ensures that each prediction is informed by probabilistic outputs and limited to relevant categories at each hierarchical stage.

By progressively narrowing choices and focusing computations only on categories relevant to the selected super-category, the nested inference system maintains high efficiency and avoids unnecessary processing. This design not only speeds up the inference process but also ensures fine-grained classification, enabling accurate distinctions between broad document types and their specific subtypes. The model's hierarchical prediction framework is well-suited for tasks requiring organized categorization, such as document classification across diverse domains.

The methods described herein, including hierarchical classification, automated data labeling, dynamic synthetic data generation, and selective model optimization, can be seamlessly integrated into a multimodal classification system designed to process and categorize input data in a plurality of formats. These methods enhance the system's ability to classify diverse data into hierarchical categories while improving efficiency and scalability. During model training, the automated data labeling pipeline, which utilizes Large Language Models (LLMs) to generate super-category, sub-category, and granular-category labels, ensures consistent and scalable annotation across multimodal inputs such as text, images, and videos. Additionally, synthetic data generation powered by LLMs supplements training datasets, particularly for formats where labeled data is limited, such as scanned legal documents or medical images. This approach creates robust training data that enhances the model's ability to generalize across complex real-world tasks.

To further optimize the multimodal system, techniques like dimensional reduction using tokenizers (e.g., Bert-tiny tokenizer) and selective layer activation are applied to reduce computational overhead and latency during inference. For instance, after determining the super-category of an input, only the corresponding sub-category and granular-category layers are activated to refine the classification, minimizing unnecessary processing for irrelevant categories. This hierarchical structure efficiently handles large and diverse multimodal inputs, such as text-based legal contracts, financial spreadsheets, or medical X-rays, by systematically narrowing predictions based on probabilistic logits.

When processing input data in a plurality of formats, the system first ingests the data using format-specific preprocessing techniques, such as tokenization for text or embedding extraction for images, creating unified representations across modalities. The hierarchical classification model then identifies the super-category with the highest probability and refines the classification within this category, narrowing to sub-category and granular-category levels. For example, a legal document might be classified as “Legal Documents” at the super-category level and further refined to “Bills_of_Sale” or “Investment_Agreements” at the sub-category level, while a medical image might be categorized under “Medical Documents” and then further into “Disease_Information” or “Treatment_Methods.”

After completing the hierarchical inference process, the multimodal system provides a unified output that includes an indication of the final classification path (e.g., super-category→sub-category→granular category). This ensures clear, structured results for diverse input formats. By combining hierarchical classification and selective layer activation, the system achieves significant reductions in latency and computational costs while maintaining high accuracy across formats. Additionally, the use of synthetic data generation ensures robust generalization and fills gaps in data availability. Together, these integrated methods create a scalable and efficient multimodal system capable of processing and categorizing input data across a broad range of formats and hierarchical categories.

Various embodiments of the system also incorporate a smoothing process to address the issue of overconfidence in prediction results. During classification tasks, the model's super-category predictions can sometimes exhibit overconfidence, where predicted probabilities are excessively close to 1, suggesting high confidence for nearly all predictions. This tendency can lead to diminished model calibration and increase the likelihood of misclassification, as the model fails to acknowledge uncertainty in its predictions. To mitigate this issue, a label smoothing approach is introduced during the model training process. Label smoothing adjusts the target probabilities slightly away from absolute values (e.g., from 1 and 0 to softer values like 0.9 and 0.1), creating a more balanced probabilistic distribution. By doing so, the model learns to be less certain about its predictions, improving generalization and reducing overconfidence.

Additionally, a refinement step is applied during model inference. Instead of utilizing hard thresholds or directly interpreting logits as probabilities, the system employs a softmax function to further address the overconfidence issue. The softmax function normalizes logits into probabilities while maintaining a smoother distribution across possible categories. This ensures that the model's predictions reflect relative likelihoods rather than extreme confidence in one particular category. Together, the combined use of label smoothing during training and softmax normalization during inference creates a more calibrated system. These techniques improve the overall reliability of the predictions across hierarchical classification stages, ensuring that the model appropriately captures uncertainty in super-category and sub-category predictions.

### § 5.1 Process for Inline Nested DLP

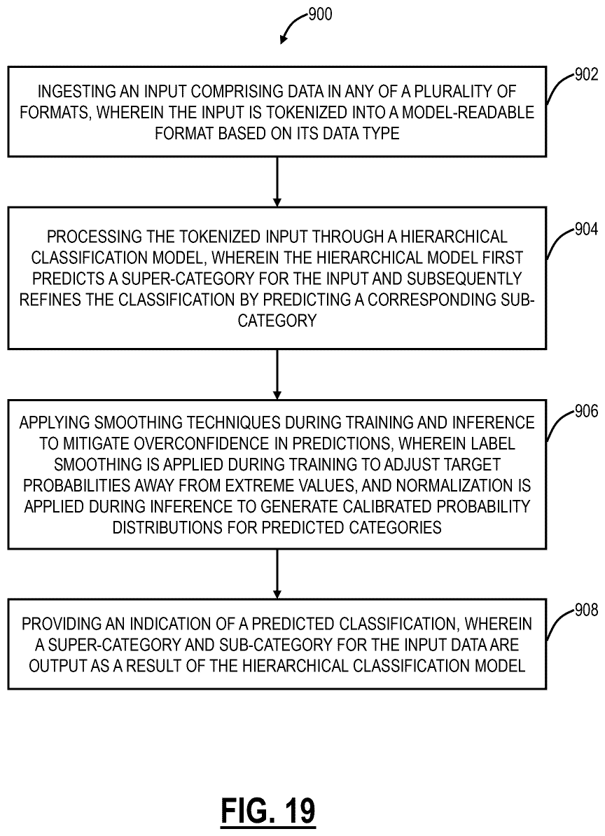

FIG. 19 is a flowchart of a process 900 for inline nested DLP. The process 900 contemplates implementation as a method having steps, via computing resources configured to implement the steps, and as a non-transitory computer-readable medium with instructions that when executed cause one or more processors to implement the steps. The process 900 can be implemented with the multimodal DLP system 550, 400, and practical implementations of the multimodal DLP system 400 and the processes 450, 480, 500, 550, 650 can be through the network configurations 100A, 100B, 100C, and the like. That is, the process 900 contemplates use with any cybersecurity monitoring platform, appliance, service, etc.

The process 900 includes ingesting an input comprising data in any of a plurality of formats, wherein the input is tokenized into a model-readable format based on its data type (step 902); processing the tokenized input through a hierarchical classification model, wherein the hierarchical model first predicts a super-category for the input and subsequently refines the classification by predicting a corresponding sub-category (step 904); applying smoothing techniques during training and inference to mitigate overconfidence in predictions, wherein label smoothing is applied during training to adjust target probabilities away from extreme values, and normalization is applied during inference to generate calibrated probability distributions for predicted categories (step 906); and providing an indication of a predicted classification, wherein a super-category and sub-category for the input data are output as a result of the hierarchical classification model (step 908).

The process 900 can be further refined with additional enhancements to improve the hierarchical classification process. In generating super-category and sub-category predictions, the model employs selective activation of sub-layers within the hierarchical classification structure. Specifically, once a super-category is identified, only the corresponding sub-model layers related to that super-category are activated to process inputs further into sub-categories. This targeted activation minimizes computational costs and improves efficiency. To enhance training datasets, synthetic data is generated using Large Language Models (LLMs), allowing for robust supplementation of the data, especially for categories with limited real-world training samples. The hierarchical classification model is also trained using an automated data labeling pipeline powered by LLMs, which generates hierarchical labels, including super-category and sub-category labels, ensuring scalability and consistency in annotation.

During inference, the system analyzes the logits associated with each hierarchical layer to identify the super-category with the highest probability, followed by selecting the sub-category within the identified super-category based on hierarchical predictions. The classification results provide detailed outputs that specify the hierarchical path traversed during classification, comprising the identified super-category and sub-category, which enables clear and structured insights. Additionally, modifications to the machine learning models are applied to reduce latency during hierarchical classification. These modifications include removing non-English words, eliminating stop words, and performing lemmatization to streamline language processing. Further optimizations are applied by enforcing a file size maximum to improve processing efficiency, with the file size limit determined based on estimated load time versus image size trend graphs.

The preprocessing phase also includes dimensional reduction techniques using tokenization with models like Bert-tiny tokenizer to create compact yet meaningful representations of input data formats prior to classification. These tokenization methods ensure efficient representation of multimodal input formats, facilitating accurate predictions across diverse data types while maintaining high computational efficiency. Together, these enhancements optimize the hierarchical classification process, delivering precise and reliable predictions while ensuring scalability and reduced latency.

### § 6.0 Conclusion

It will be appreciated that some embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including software and/or firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the approaches may be used. For some of the embodiments described herein, a corresponding device in hardware and optionally with software, firmware, and a combination thereof can be referred to as “circuitry configured or adapted to,” “logic configured or adapted to,” “a circuit configured to,” “one or more circuits configured to,” etc. perform a set of operations, steps, methods, processes, algorithms, functions, techniques, etc. on data as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. Further, the various elements, operations, steps, methods, processes, algorithms, functions, techniques, etc. described herein contemplate use in any and all combinations with one another, including individually as well as combinations of less than all of the various elements, operations, steps, methods, processes, algorithms, functions, techniques, etc.

What is claimed is:

1. A method for hierarchical classification of input data into categories of a plurality of categories, the method comprising steps of:
ingesting an input comprising data in any of a plurality of formats, wherein the input is tokenized into a model-readable format based on its data type;
processing the tokenized input through a hierarchical classification model, wherein the hierarchical classification model first predicts a super-category for the input and subsequently refines the classification by predicting a corresponding sub-category;
applying smoothing techniques during training and inference to mitigate overconfidence in predictions, wherein label smoothing is applied during training to adjust target probabilities away from extreme values, and normalization is applied during inference to generate calibrated probability distributions for predicted categories; and
providing an indication of a predicted classification, wherein a super-category and sub-category for the input data are output as a result of the hierarchical classification model.

2. The method of claim 1, wherein generating super-category and sub-category predictions utilizes selective activation of sub-layers within the hierarchical classification model, wherein only sub-model layers corresponding to an identified super-category are activated to process inputs further into sub-categories, thereby reducing computational costs.

3. The method of claim 1, wherein synthetic data is generated using Large Language Models (LLMs) to supplement a training dataset.

4. The method of claim 1, wherein the hierarchical classification model is trained using an automated data labeling pipeline, wherein the pipeline utilizes Large Language Models (LLMs) to generate hierarchical labels, including super-category and sub-category labels, for input data.

5. The method of claim 1, wherein during inference, logits associated with each hierarchical layer are analyzed and a category with a highest probability for the super-category is selected, followed by a selection of a sub-category based on hierarchical predictions corresponding to the identified super-category.

6. The method of claim 1, wherein the indication of the hierarchical category classification includes providing detailed outputs that specify a hierarchical path traversed during classification, comprising the identified super-category and sub-category.

7. The method of claim 1, wherein the steps include performing one or more modifications to one or more machine learning models associated with the hierarchical classification model to reduce latency.

8. The method of claim 7, wherein the one or more modifications include any of removing, from the one or more machine learning models, non-English words, removing stop words, and performing lemmatization.

9. The method of claim 7, wherein the one or more modifications include enforcing a file size maximum, wherein the file size maximum is determined based on one or more estimated load time vs image size trend graphs.

10. The method of claim 1, wherein the hierarchical classification model performs dimensional reduction during preprocessing using tokenization techniques, including Bert-tiny tokenization, to create compact yet meaningful representations of the input data formats prior to classification.

11. A non-transitory computer-readable medium comprising instructions that, when executed, cause one or more processors to perform steps of:
ingesting an input comprising data in any of a plurality of formats, wherein the input is tokenized into a model-readable format based on its data type;
processing the tokenized input through a hierarchical classification model, wherein the hierarchical classification model first predicts a super-category for the input and subsequently refines the classification by predicting a corresponding sub-category;
applying smoothing techniques during training and inference to mitigate overconfidence in predictions, wherein label smoothing is applied during training to adjust target probabilities away from extreme values, and normalization is applied during inference to generate calibrated probability distributions for predicted categories; and
providing an indication of a predicted classification, wherein a super-category and sub-category for the input data are output as a result of the hierarchical classification model.

12. The non-transitory computer-readable medium of claim 11, wherein generating super-category and sub-category predictions utilizes selective activation of sub-layers within the hierarchical classification model, wherein only sub-model layers corresponding to an identified super-category are activated to process inputs further into sub-categories, thereby reducing computational costs.

13. The non-transitory computer-readable medium of claim 11, wherein synthetic data is generated using Large Language Models (LLMs) to supplement a training dataset.

14. The non-transitory computer-readable medium of claim 11, wherein the hierarchical classification model is trained using an automated data labeling pipeline, wherein the pipeline utilizes Large Language Models (LLMs) to generate hierarchical labels, including super-category and sub-category labels, for input data.

15. The non-transitory computer-readable medium of claim 11, wherein during inference, logits associated with each hierarchical layer are analyzed and a category with a highest probability for the super-category is selected, followed by a selection of a sub-category based on hierarchical predictions corresponding to the identified super-category.

16. The non-transitory computer-readable medium of claim 11, wherein the indication of the hierarchical category classification includes providing detailed outputs that specify a hierarchical path traversed during classification, comprising the identified super-category and sub-category.

17. The non-transitory computer-readable medium of claim 11, wherein the steps include performing one or more modifications to one or more machine learning models associated with the hierarchical classification model to reduce latency.

18. The non-transitory computer-readable medium of claim 17, wherein the one or more modifications include any of removing, from the one or more machine learning models, non-English words, removing stop words, and performing lemmatization.

19. The non-transitory computer-readable medium of claim 17, wherein the one or more modifications include enforcing a file size maximum, wherein the file size maximum is determined based on one or more estimated load time vs image size trend graphs.

20. The non-transitory computer-readable medium of claim 11, wherein the hierarchical classification model performs dimensional reduction during preprocessing using tokenization techniques, including Bert-tiny tokenization, to create compact yet meaningful representations of the input data formats prior to classification.
